(19) United States
(12) Patent Application Publication
(10) Pub. No.: US 2017/0121039 A1
(43) Pub. Date: May 4, 2017

(54) Seamless Paintball and Encapsulation Method

(71) Applicant: Paul M. Ciesiun, Mokena, IL (US)

(72) Inventor: Paul M. Ciesiun, Mokena, IL (US)

(21) Appl. No.: 15/338,719

(22) Filed: Oct. 31, 2016

Related U.S. Application Data
(60) Provisional application No. 62/285,536, filed on Oct. 30, 2015.

(51) Int. Cl. B65B 3/00; F42B 12/40; B33Y 40/00; B33Y 80/00; B29C 67/00; B33Y 10/00

(52) U.S. Cl. CPC B65B 3/00; B29C 67/0055; B33Y 10/00; B33Y 40/00; B33Y 80/00; F42B 12/40

(57) ABSTRACT

The present invention provides a seamless capsule for delivering a material inside said capsule to a destination requiring the encapsulated material includes a shell having a uni-body construction with a fill aperture in a top portion to receive a predetermined material in a cavity defined by an inner wall of the shell. The shell has an outer wall with a predetermined configuration corresponding to the intended use of the seamless capsule. Further, the seamless capsule includes a cover integrally joined to the top portion of the shell to cover fill aperture in the top portion of the shell after the material is disposed in the cavity.

The present invention also provides a method for encapsulating a material for delivery to a predetermined destination requiring the encapsulated material. The method includes the steps of fabricating a seamless shell with a fill aperture in a top portion to receive a predetermined material in a cavity defined by an inner wall of the shell. The shell includes an outer wall with a predetermined configuration corresponding to the intended use of the seamless shell. The method further includes fabricating a seamless cover upon the top portion of the seamless shell to cover the aperture in the top portion of the shell after the material is disposed in the cavity.

This Utility application is based on Provisional Application No. 62/285,536 filed on Oct. 30, 2015

### BACKGROUND OF THE INVENTION

1. Field of the Invention

This invention relates to a capsule having a predetermined configuration without seams or other imperfections that would diminish the performance of the capsule for its intended use. Further, this invention relates to a method for fabricating a capsule having a configuration that optimizes the capsules performance while executing its intended use or function

2. Background of the Prior Art

Prior art capsules are fabricated by encapsulation methods that result in capsules having seams and/or imperfections that have a negative impact on the goals required of the capsules when performing their intended functions. The “capsule” of the present invention provides a delivery system for materials that cannot be encased by typical encapsulation methods. Further, The capsule of the present invention cannot be fabricated by typical encapsulation methods.

The methods of creating a capsule or projectile for various uses are well known in the prior art. However, the prior art is crowded with failed attempts to overcome one of the most difficult aspects of fabricating a capsule/projectile, which is the sealing of a spherical capsule after a material has been disposed inside the capsule. Some prior art methods fabricate a capsule by forming capsule “halves” via dies or rotary dies during or prior to filling the capsule with a predetermined material. Alternative prior art methods form capsule halves via injection molding, blow molding, thermoforming and asymmetrical parts. Irrespective of the prior art method used to fabricate capsule halves, the halves must then be secured together to form a liquid tight seal by using processes such as adhesive, ultra-sonic welds, solvent welds and similar sealing methods well known to those of ordinary skill in the art. Further, the halves must be secured together to form a capsule having a geometry (spherical, cylindrical, conical, etc.) to near perfect tolerances. This further requires the employment of tooling and other safeguards to make sure that top and bottom capsule halves are properly located prior to sealing. Failure to do this results in incomplete joining of the cooperating halves. Weak welds, seams that leak and joints that have flanges, burs and other undesirable features are also common as a result of size differential, alignment failures, and/or weak part to part securing means.

Still another method the prior art provides to join two halves to form the capsule is the employment of positive and negative charged halves to properly align the two halves. Further, in instances where multiple fills are to be encapsulated, and are required to be separated until use, an interior barrier is typically employed. Here, the partition of shell material must be provided such that it can be welded to a shell half after it is filled. This method in the prior art is employed to create compartments within the capsule to separate fill materials wherein it is not desirable for them to mix until impact. In order to provide this compartment, a layer of material must be welded to the desired half, or to each half, and the removal of the excess material at the outer wall of each half.

Thus, the prior art presents a myriad of alternatives to encapsulation, all of which are inferior with respect to the scope of the present invention. Therefore, the present invention provides a method to form a new single unit capsule free of welds, seams, and multiple components that must be welded together to create a single capsule. This capsule or projectile can be used to encapsulate commonly or uncommonly used liquid and non-liquid components for various applications and industries.

### SUMMARY OF THE INVENTION

It is an object of the present invention to overcome many of the disadvantages associated with prior art capsules and the method of fabricating capsules. A principal object of the present invention is to provide a capsule having a configuration that optimizes the performance of the capsule for the intended use of the capsule. A feature of the capsule configuration is a single unit shell having a cavity therein that ultimately receives a predetermined liquid material. Another feature of the capsule configuration is a single unit shell that is constructed about a solid material. An advantage of the capsule configuration is that the single unit shell construction avoids using half shells or similar shell portions, thereby avoiding the use of sealing methods to join the portions together that could result in material escaping from the shell.

Another object of the present invention is to provide a method for fabricating a capsule having a configuration that optimizes the performance of the capsule for the intended use of the capsule. A feature of the method for fabricating the capsule is the use of a 3 D Printer programmed to construct a capsule shell having a “uni-body”or single part construction with a predetermined configuration that optimizes the performance of the capsule for the intended use of the capsule. An advantage of the method for fabricating the capsule is that the 3 D Printer constructs a “one part” capsule shell without using any sealing agents to join any portions of the uni-body shell.

Yet another object of the invention is to provide a method for filling the cavity of a capsule shell without using any sealing agents. A feature of the method for filling the cavity is to program the 3 D Printer to provide a relatively small liquid fill aperture in the top portion of the shell. An advantage of the method is that a relatively small fill nozzle can be inserted into a top portion of the shell cavity, whereupon, a liquid fill material is injected into the shell until substantially the entire cavity is filled with the liquid. Another advantage of the method is that the 3 D Printer is programmed to generate a “cover” over the fill aperture such that the outer wall of the shell is geometrically uniform and without any surface discontinuities, perturbations, recess, or imperfections that would alter the configuration of the outer wall of the shell, thereby maintaining the optimum performance of the capsule, irrespective of the intended use of the capsule.

Still another object of the invention is to provide a method for fabricating multiple capsules with one 3 D Printer. A feature of the method is to provide a 3 D Printer having a horizontal bar or first gantry supporting a predetermined quantity of shell material forming ejectors with bottom nozzles. Another feature of the method is to dispose the ejectors such that the fabricated capsule shells are equally separated upon a platform under the ejectors. Yet another feature of the method is that the 3 D Printer includes a second gantry supporting a corresponding liquid fill material ejector for each shell material forming ejector to eject liquid fill material into each formed shell. An advantage of the method is that one 3 D Printer can be programmed to simultaneously fabricate multiple shell and simultaneously fill the shells to form multiple capsules on one plateform.

The present invention employs a method of encapsulation that provides a capsule that is hermetically sealed as a single part and does not rely on two equal or disparate halves to create the whole. The present invention employs three-dimensional layering of extruded material as a way to construct the outer shell wall of the capsule. While three-dimensional printing is well known in the prior art, employing it to provide a hollow three-dimensional structure that can incorporate liquids or solids is novel.

The present invention employs a multi-axis (3 or more), computer controlled gantry with an attached extruder, and dispensing nozzle on the extruder. The extruder melts shell material and dispenses said shell material through the nozzle in thin layers on a platform, such that the layers are “built up” to the desired height, width and thickness. These layers of material then harden after extrusion and combine to consist of the outer shell wall of a capsule. This is defined as an additive process.

The shell wall is formed, via an extrusion apparatus, dispensing at a fixed point onto either a flat platform, or a platform with a recess to receive and hold the material as it is successively placed. This initial location could be defined as the “south pole” of the capsule for ease of reference. Thereafter the gantry moves 360 degrees in a circular motion (for spheres), while dispensing molten material via the nozzle in additive layers. The gantry then moves as necessary away from the starting point and then steps “up” the z-axis to create each successive layer. This is repeated until the outer shell wall reaches the desired geometry is created. In the instance of a capsule, or one embodiment of the present invention, this would be a hollow sphere.

In instances where a material will be dispensed within the capsule, the gantry does not complete the sum of the successive layers to complete the outer shell wall fabrication. Instead, the extrusion nozzle and gantry will pause the build-up of additive layers at a pre-designated location in the build process. This is controlled by a computer/program that controls the gantry movement, amount of material dispensed, etc. Typically this stopping of additive layer building would be very near the completion of the geometry. As it relates to this invention, this will leave an opening in the shell wall sufficient enough to dispense a volume of liquid into, and thus neither the capsule geometry nor the part fabrication process would be considered complete.

After stoppage of additive layer building, a dispensing nozzle is presented over the area of the capsule exposing the hollow interior volume. This dispensing nozzle could be fixed to the same gantry as the extrusion nozzle, or be independent. In either instance, the purpose of this nozzle is to dispose the desired material, to be encapsulated, into the cavity. The dispensing nozzle provides a precise volume typically supplied from a positive displacement fluid dispense system.

Thus, the once vacant interior of the capsule that was formed by building the outer shell in successive layers is now filled with the liquid that was dispensed via the dispensing nozzle. Thereafter, the dispensing nozzle is removed and the extrusion nozzle resumes its pattern of additive layers until the final outer shell geometry is formed.

The present invention employs the successive layering of extruded outer shell material, dispensed via an extrusion nozzle until a geometry comprising an outer shell is created sufficient to provide a cavity to encapsulate either liquid or solid. The building of additive layers can be paused at any time during the exterior wall print process to permit the dispensing nozzle (inner fill or solid) to dispose the desired type, amount, or quantity of material in the formed cavity. This process can even be repeated so that the extrusion nozzle and dispensing nozzle alternate as the shell wall is built in successive layers along the z-axis forming the final part.

The advantages of the present invention are thus easily recognized. The system is highly efficient in that it extrudes either exactly the desired amount of shell material to be employed in the final product and in the geometry needed. Less would mean that the entirety of the outer shell wall was not complete, and an alternative method would be needed to seal the capsule.

Further, the present invention no longer has any seams and thus does not permit the possibility of a weak weld at the seam between similar or dissimilar materials. The equator will now also be free from burs, and flanges, or offsets that may occur as a result of two separate halves being joined. In addition, the volume of the capsule is very precise and provides an efficient way to dispense the materials into the cavity without waste.

Also, because successive layers of shell material are built in two-dimensional “slices” of shell wall, it is relatively easy to build interior chambers, cavities, and geometries that cannot be found anywhere in the prior art. In instances where liquids and solids need to be encapsulated, but separate until the designated time subsequent to impact of a projectile or breaking of a capsule, these cavities prevent interaction.

In addition, the construction of the outer shell wall can include components not found in any of the prior art. These components can include, but not limited to channels, groves, relatively thin and thick portions, stems, dividing walls, and support structures can, all of which can be built within the shell wall via the additive layer process. These structures can take on a complex, corresponding and even cooperative roles depending on the feature required. Besides the aforementioned features, the shell wall can include textures and aerodynamic components such as fins, groves, intake and/or flow through geometry. For example, if a channel is required to run through the entire capsule, the channel can be built within the capsule via the layering process.

The necessity to create a multitude of capsules for the purposes of mass production is also recognized by this invention. In this instance, a multitude of extrusion nozzles, separated by the desired distance, can be arranged in a matrix of multiple nozzles to cooperate together to dispense at the same time, the same part geometry to create multiple capsules at one time. This system would also provide a matrix of dispensing nozzles in the same array to provide liquid or solids to the capsules at the designated time. Further, multiple gantries could be employed for both extrusion and filling. Filling could occur on the same platform, or the platform could be moved to a second station that presents the material to be encapsulated, while a third and final station presents extrusion nozzles to provide the remaining material to close the capsules and fully encapsulate the material.

The shell material of the present invention includes but is not limited to materials such as gelatins, plasticizers, waxes, natural or synthetic plastics, synthetic polymers, polyesters, polyhydroxyalkanoate (PHA), polylactic acid (PLA), starch copolymers (corn, potato, rice, wheat, grass, etc.), high molecular weight polyvinyl alcohol, unstabilized polyethylene, unstabilized polypropylene, polystyrene, oxo-biodegradable polyolefin, UV degradable polymers and combinations thereof, or any material that is capable of being extruded and built into successive layers via the aforementioned method.

The fill material of the present invention, in the preferred embodiment as a paintball projectile includes, but is not limited to a combination of water, thickening agents, opacifiers, dispersing agents, pigments/dyes (for color), and preservatives. In the present invention it is desirable at times to use multiple dispense nozzles to provide fill materials of varying colors.

The present invention provides a seamless capsule for delivering a material inside the capsule to a destination requiring the encapsulated material. The seamless capsule includes a shell having a uni-body construction with a fill aperture in a top portion to receive a predetermined material in a cavity defined by an inner wall of the shell. The shell has an outer wall with a predetermined configuration corresponding to the intended use of the seamless capsule. The capsule further includes a cover integrally joined to the top portion of the shell to cover the aperture in the top portion of the shell after the material is disposed in the cavity, resulting in the outer wall of the shell maintaining the predetermined configuration after the cover is integrally joined to the top portion of the shell, thereby maintaining the optimum performance of the seamless capsule until delivering the material to a predetermined destination.

The invention further provides a method for encapsulating a material for delivery to a predetermined destination requiring the encapsulated material. The method includes the steps of fabricating a seamless shell with a fill aperture in a top portion to receive a predetermined material in a cavity defined by an inner wall of the shell. The shell has an outer wall with a predetermined configuration corresponding to the intended use of the seamless shell. The method further includes the step of fabricating a seamless cover upon the top portion of the seamless shell to cover the aperture in the top portion of the shell after the material is disposed in the cavity, resulting in a seamless encapsulation of the material, resulting in a seamless encapsulation providing seamless shell with a seamless outer wall that maintains said predetermined configuration after the cover is fabricated upon the top portion of the shell, thereby maintaining the optimum performance of the seamless shell until delivering the material inside the seamless shell to a predetermined destination.

The invention also provides a method for manufacturing multiple capsules for encapsulating a material for delivery to a predetermined destination requiring the encapsulated material. The method includes the steps of fabricating multiple seamless shells with each having a fill aperture in a top portion to receive a predetermined material in a cavity defined by an inner wall of the shell. Each seamless shell has an outer wall with a predetermined configuration corresponding to the intended use of the seamless shell. The method further includes fabricating multiple seamless covers upon each of the top portions of the multiple seamless shells to cover each of the apertures in each of the top portions of the multiple shells after the material is disposed in each of the cavities, resulting in multiple seamless encapsulations of the material that provide multiple seamless shells each with a seamless outer wall that maintains the predetermined configuration after the covers are fabricated upon the top portions of the shells, thereby maintaining the optimum performance of each of the multiple seamless shells until delivering the material inside each of the seamless shells to predetermined destinations.

### BRIEF DESCRIPTION OF THE DRAWINGS

The foregoing invention and its advantages may be readily appreciated from the following detailed description of the preferred embodiment, when read in conjunction with the accompanying drawings in which:

FIG. 1 is a perspective view of a portion of a 3 D Printer depicting a horizontal gantry supporting an injector with a bottom nozzle that is forming a spherical capsule shell upon a platform in accordance with the present invention.

FIG. 2 is a perspective view of a portion of a 3 D Printer depicting a horizontal gantry movable upon a lower portion of a platform. The gantry supports multiple ejectors that are capable of horizontally and vertically movement to form capsule shells upon an upper portion of a platform in accordance with the present invention.

FIG. 3 is a perspective view of FIG. 2 but with a single capsule shell forming ejector secured to the gantry, and with an added gantry for supporting an injector for filling the capsule shells with a predetermined liquid in accordance with the present invention.

FIGS. 4A-E depict a series of front elevation views of stages of forming a spherical capsule shell. The different views depict a phantom view of the shell wall during the construction process by the 3 D Printer.

FIGS. 5A-C depict a series of front elevation views of the filling process of a capsule shell via a fill aperture in a top portion of the shell. FIG. 5C depicts a finished capsule after the 3 D Printer has finished the construction of the shell after the liquid fill material has been injected into the shell in accordance with the present invention.

FIGS. 6A-C depict a series of front, phantom elevation views of sphere configured capsules depicting different internal constructions of sphere capsules in accordance with the present invention.

FIGS. 6D-F depict a series of front elevation views of methods for supporting sphere configured capsules without distorting the capsule during the fabrication process of a sphere configured capsule.

### DESCRIPTION OF THE PREFERRED EMBODIMENT

Referring to the figures, in the preferred embodiment, the capsule 8 of the present invention is seamless because it is not welded at the equator or any other area. Further, it encapsulates a colored, single stage liquid fill material and is used to create a new paintball projectile. Traditional gelatin paintballs are constructed of two shell halves via the rotary die process and rely on the solvent “welding” of these halves to encapsulate a material. These welds present themselves as “seams” at the equator of the paintball. This can be problematic if the weld fails, is weak, or has leaks along it. Further, alternative encapsulation methods that employ a seam such as that found in U.S. Pat. No. 8,342,099 (Delhaye et. al.) and U.S. Pat. No. 7,905,181 (Ciesiun et. al) provide an opportunity for the integrity of the encapsulation to be compromised prior to use. Defects such as burs, flanges, offsetting of the two halves, and even leaking occur frequently. Moreover, the additive layering of the shell material provides the exact, and final geometry desired for the part. There is no post forming processes to remove the geometry from a webbing such as die cut, laser cutting, RF welding/cutting, etc.

Wherein Ciesiun et al teaches us that two shell halves are formed separate and joined during a radio frequency welding and thereafter cut out by some means, the present invention forms the shell geometry as required. Once mostly formed, it only requires dispensing of the fill material into the cavity and final additive layers to be placed to complete the process.

Thus, the present invention of a seamless capsule 8 built via additive layers resolves issues such as those mentioned. Wherein traditional projectile production requires large footprints for equipment and highly precise tooling, the present invention can create capsules on a tabletop. The elimination of processes such as thermoforming, radio frequency welding, rotary die cutting, drying, laser/die cutting, etc. are all eliminated by the present invention making it most efficient. The process of the present invention also eliminates the method of sealing two halves together, by some means, to create a capsule. It eliminates laminate layers disposed perpendicularly along the lower or upper capsule half to create interior chambers. It also eliminates the need for air gaps to be preserved at the equator to provide excess internal volume to generate an effective weld. Therefore, it should be evident, that the benefits of this new method to create paintballs would therefore far outweigh those of traditional paintballs and alternative paintball manufacturing methods of the prior art.

The preferred embodiment of the present invention employs an extrusion grade, oxo-degradable polylactic acid. This shell material would be heated to the requisite processing temperature via the extrusion system and dispensed via the extrusion nozzle onto the build platform. An example of a three dimensional extruder is Microsoft®'s Makerbot Replicator.

Successive layers of the PLA would be built such that a paintball capsule would begin to be formed. The typical wall thickness of these layers may be anywhere from 0.004″-0.025″ depending on the end use application. For paintball projectiles, the desired thickness for breakage would set the wall thickness at approximately 0.010″ thick. The outer diameter of this paintball is approximately 0.680″-0.695″ and provides approximately 3 mL of liquid material. The final weight of the capsule being approximately 2.5-3.5 grams.

Once the shell wall 10 is near complete, the extrusion would cease temporarily. then a dispense nozzle would be fixed above the capsule geometry and dispense a single stage liquid fill material 12 into a cavity 14. This fill material 12 would be comprised mostly of water, a thickening agent to achieve the desired viscosity for marking a target, colored pigments, opacifiers such as titanium dioxide, preservatives (to prevent mold growth), and sorbic acid, or potassium sorbate. Further, a density modifier would also be added to ensure a very accurate projectile weight could be achieved.

After the liquid fill 12 is dispensed, the additive layering process again resumes to close the interior volume or cavity 14 until the fill 12 is encapsulated. The finished part is then removed from the build platform 16 and then is ready to be packaged for use.

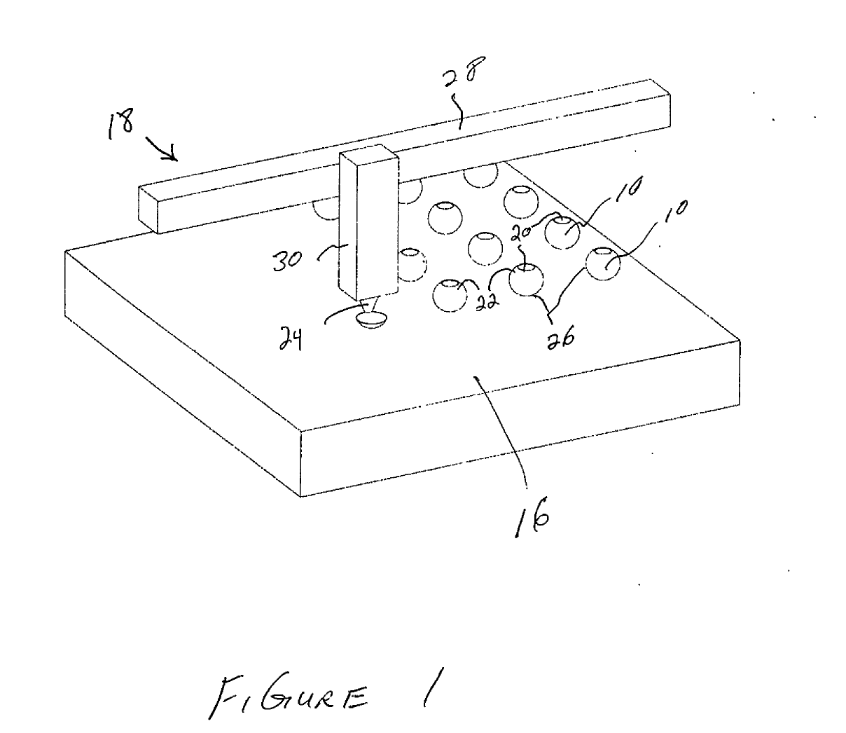

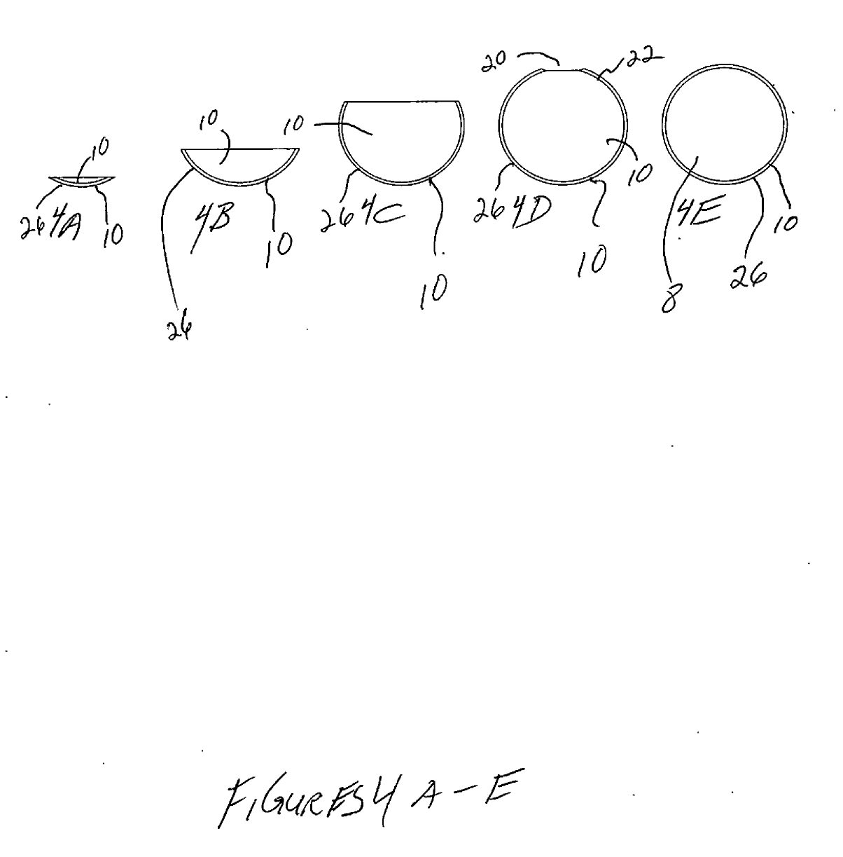

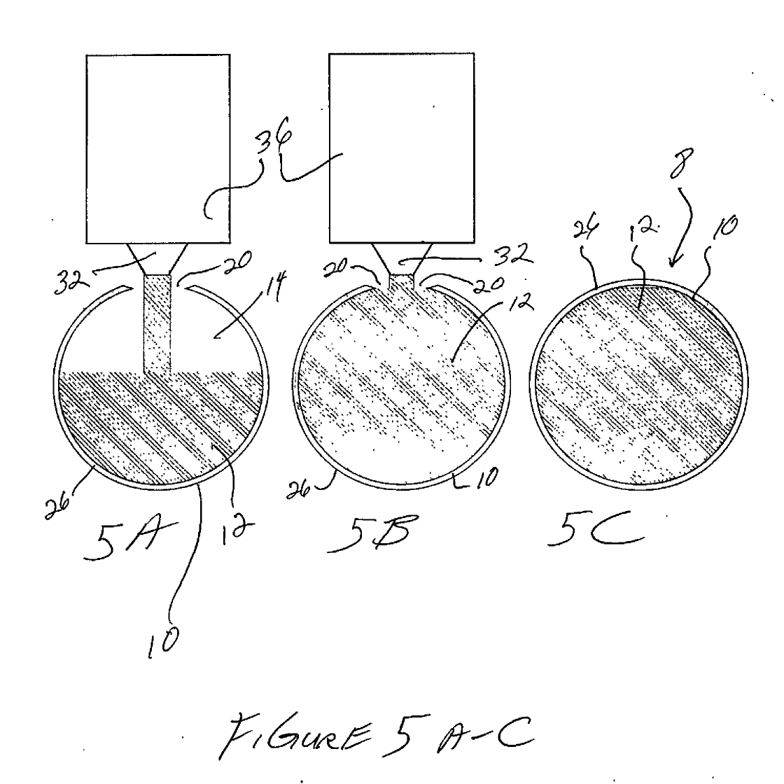

Referring to FIGS. 1, 4 and 5, the present invention further provides a method for fabricating a capsule 8 having a configuration that optimizes the performance of the capsule for the intended use of the capsule. The capsule is fabricating via 3 D Printer 18 programmed to construct a capsule shell 10 having a “uni-body” or single part construction with a predetermined configuration that optimizes the performance of the capsule 8 for the intended use of the capsule 10. The 3 D Printer constructs a “one part” capsule shell 10 without using any sealing agents to join any portions of the uni-body shell 10.

The programming of the 3 D Printer includes the providing of a relatively small liquid fill aperture 20 in a top portion of the shell 10. The aperture 20 allows a relatively small fill nozzle 24 to be inserted into the top portion 22 of the shell cavity 14, whereupon, a liquid fill material 12 is injected into the shell 10 until substantially the entire cavity 14 is filled with the liquid 12. The 3 D Printer is programmed to “cover” the fill aperture 20 such that an outer wall 26 of the shell 10 is geometrically uniform, thereby maintaining the optimum performance of the capsule 10, irrespective of the intended use of the capsule.

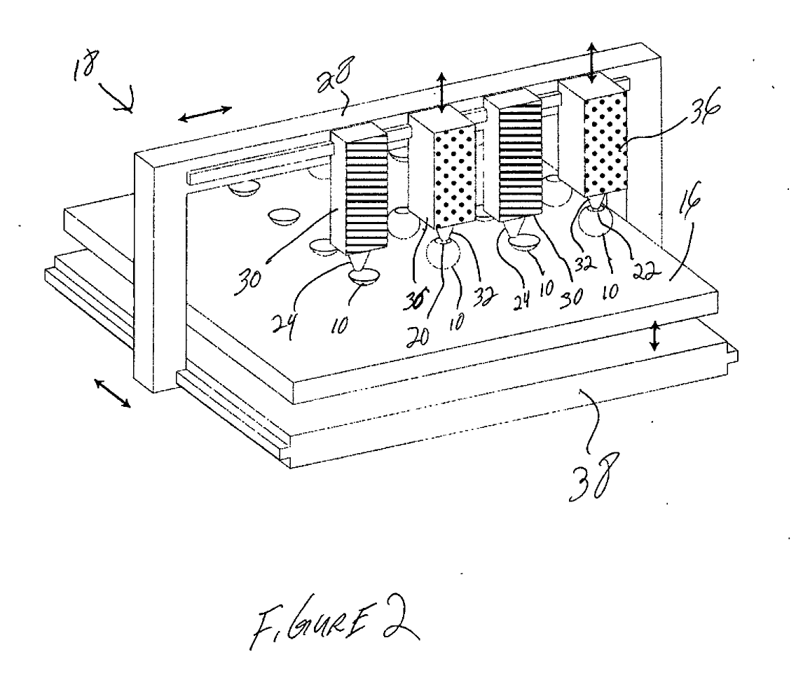

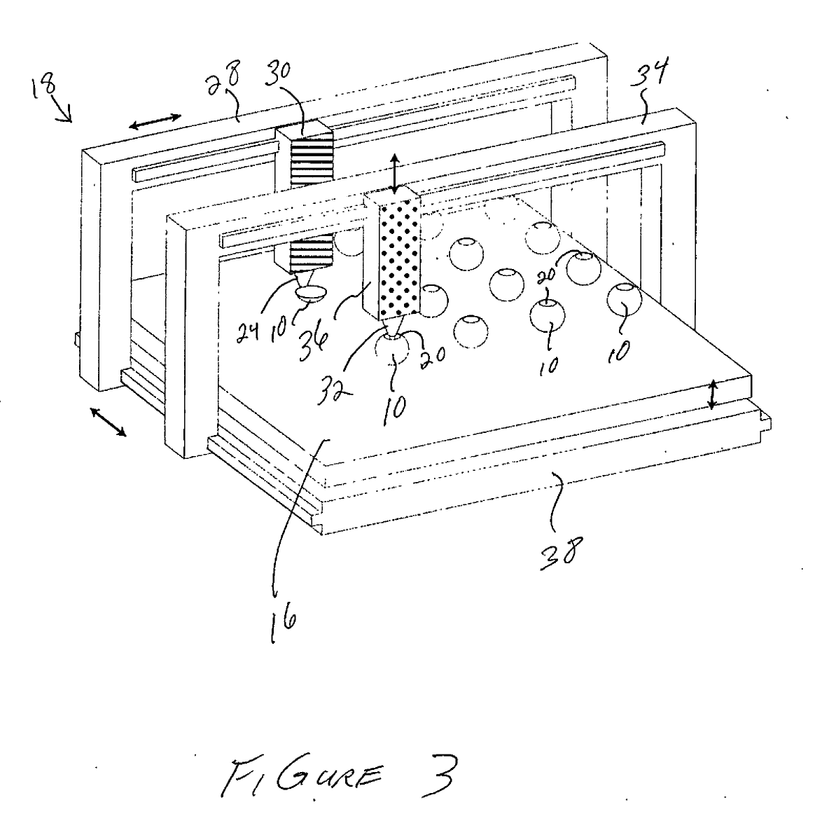

The 3 D Printer 18 is also capable of fabricating multiple capsules 8 upon one build platform 16. To achieve the fabrication of multiple capsules 8, the 3 D Printer 18 includes a horizontal bar or first gantry 28 supporting a predetermined quantity of shell forming ejectors 30 with bottom nozzles 24. The ejectors 30 fabricate and equally separate the shells 10 upon the platform 16 under the ejectors 30. To fill the shells 10 with the liquid fill material 12, the 3 D Printer includes a second gantry 34 (see FIGS. 2 and 3) supporting a corresponding liquid fill material ejector 36 with bottom nozzles 32 for each shell forming ejector 30 to eject liquid fill material 12 into each formed shell 10 via the fill aperture 20.

Referring to FIGS. 2-5, one 3 D Printer 18 can be programmed to simultaneously fabricate multiple shells 10 and simultaneously fill the shells 10 to form multiple capsules 8 on one platform 16. The simultaneous fabrication and filling of the shells 10 is achieved by the 3 D Printer's 18 programming controlling horizontal movement of the first and second gantries 28 and 34 upon a lower platform 38, and controlling horizontal and vertical movement of the shell forming ejector(s) 30 secured to the first gantry 28, and controlling horizontal and vertical movement of the liquid fill material ejector(s) 36 secured to the second gantry 34. Alternatively, one gantry 28 maybe used to support both shell forming ejectors 30 and liquid fill material ejectors 36 such that both sets of ejectors 30 and 36 may be horizontally and vertically positioned upon the gantry 28 by the 3 D Printer to facilitate multiple shell 10 forming and shell 10 filling fabrications.

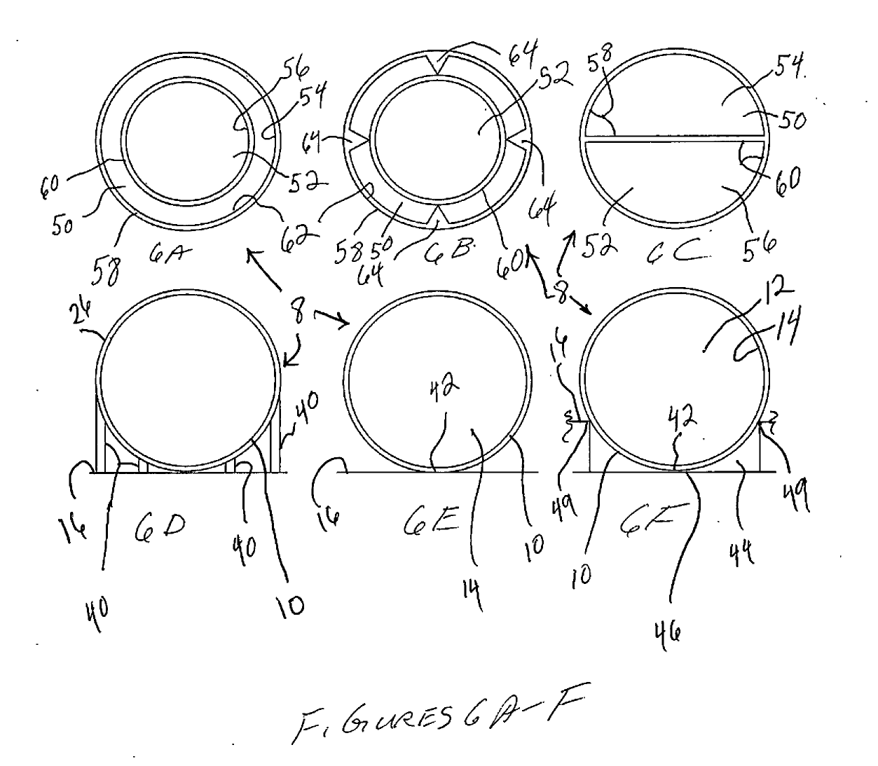

Referring to FIGS. 6 D-F, a series of front elevation views of methods or structures for supporting sphere configured capsules 8 without distorting the capsule 8 during the fabrication process of a sphere configured capsule are depicted. A first capsule support method (FIG. 6 D) includes vertical column structures 40 vertically secured to the building platform 16 and bottom portions of the outer wall 26 of the shell 10. The columns 40 are fabricated by the 3 D Printer 18 from the same material that forms the shell 10 of the capsule 8.

A second capsule support method is depicted in FIG. 6 E, which includes the shell 10 being fabricated upon the platform 16 with no added structures, but with a the shell 10 material that hardens and provides a relatively more rigid surface that engages the platform 16 via a bottom portion 42 that maintains a spherical configuration when the liquid fill material 12 is injected into the shell cavity 14.

A third capsule support method is depicted in FIG. 6 F, which includes the shell 10 being fabricated within a recess 44 in the platform 16, such that a bottom portion 44 of the shell 10 engages a corresponding bottom portion 46 of the recess 44, and an annular lower portion 48 of the shell 10 engages a cooperating annular edge portion 49 of the recess 44 as the shell 10 is being fabricated, thereby maintaining the position of the shell 10 upon the platform 16 throughout the shell 10 fabrication and the filling of the cavity 14 with the liquid fill material 12.

### Preferred Field of Use

As a paintball projectile, the present invention serves the purpose of encapsulating materials that are expelled from the projectile upon impact of a target, within a designated game or exercise activity. Those materials are typically encapsulated in animal based gelatin, and are oil based fills. One purpose of the present invention is to provide an alternative outer shell material of the projectile. This permits alternative fill materials for paintballs such as water. Due to the high cost of oil based fill materials and outer shell animal based shell materials, the present invention attempts to provide a method to encapsulate water to lower the costs of a single projectile.

Further, this invention provides a device and method to encapsulate materials that are regulated by the Food and Drug Administration. It has long been desirable to provide a method that encapsulates materials that are not compatible with moisture sensitive outer shell materials.

In addition, the present invention provides a capsule that can be employed in a wide range of industries such as aerospace, agriculture, police/military applications, pharmaceutical, home and self-defense, other recreational uses such as hunting, conservation, and other industries wherein an alternate encapsulation method exists to create a capsule that cannot be otherwise created via conventional methods.

### Alternate Embodiments

### Multi-Phase Fill Paintball

Yet another alternative embodiment is a paintball comprising of multiple colored fill materials 12 to provide a unique “mark” on a target. In instances where multiple fill colors are desirable, a thixotropic thickener such as those specified in Ciesiun etc. al. could be employed in the liquid fill material. This thickening agent would then permit a first liquid to be dispensed into the cavity until a desired amount consumes the requisite volume of the interior cavity. This first liquid may contain pigments or dyes to provide a color to it. A second dispense nozzle could then be presented above the cavity for the purposes of dispensing a second fill liquid of a different color into the cavity. The thixotropic thickener would then provide a resting viscosity that would prevent the fill materials from becoming homogenous, thereby providing a seamless capsule with a multi-phase fill disposed therein.

### Multi-Colored Capsule

Still another alternative embodiment is the employment of multiple colors in the outer shell 10 to provide a wide product mix and to provide a uniquely identifiable product. This occurs by providing multiple colors of material to be extruded in the additive layer process.

### 3D Geometry

Another alternative embodiment provides for the layering to add patterns, geometrical shapes, symbols, logos or other identifiable geometries to the outer shell wall. For example, a team logo can be incorporated as a positive or negative to the outer shell wall so that it provides a unique product to the end user or serves as the purpose of providing a distinct product easily recognized.

### Encapsulation of Electronics, Microchips, Batteries, Etc.

One alternative of the present invention is to provide a capsule, produced via the additive layer method that provides internal geometries to support encapsulated solid structures. One such example is the positioning, or attachment of a microchip, micro-processer, or other electronic components. These internal geometries comprise support structures, membranes or webbing that supports these components to be held into a fixed position until the shell is fractured and the internal component is disposed in the desired location. For example, an additive layer that provided a thin walled barrier between an electronic circuit and a power source can provide contact between the circuit and power source at the desired time. This would then provide power to the electronic circuit to initiate a predetermined circuit output.

### Different Sizes

The paintball of the preferred embodiment provides for a capsule that is approximately 0.680″-0.695″ in diameter. As an alternative, a capsule may increase, or decrease in size to accommodate the required internal volume. Thus, relatively smaller, and relatively larger capsules can be created for the requisite end use purpose.

### Agriculture

Yet another embodiment of the present invention is the production of a capsule for use in agriculture. The ability to encapsulate liquids, solids, or semi-solids provides a dynamic opportunity in agriculture. In the present invention, it is possible to encapsulate seeds, water, and even nutrients that are separated until such time as it is needed. The combination of encapsulated ingredients that promote the growth of plant life can therefore be self-contained and placed where needed, safely and without concern for common problems such as drought, fungi, animals etc. Thus the object of this alternative embodiment would be to provide a capsule that can be used to stave off times of drought, replenish nutrients to soils sapped from harsh crops such as corn, or provide components to plant life to prevent disease or insect infestation. This eco capsule can then be placed where needed, at a time when needed.

In conditions wherein seeding may be exceedingly difficult, the capsule of the present invention can be employed to provide seeds a better opportunity to sprout and root by providing an immediate nutrient and moisture source. The encapsulation of a “seed system” provides a unique method of seeding and permitting plants to root.

Further, projectiles that contain a liquid or solid (powder or unitary body) herbicide, pesticides and insecticides may also be encapsulated in order to provide ease of use in eliminating non-desirous plant life, invasive species, and other relevant nuisances. These herbicides may be selective or non-selective of the plant they target. Kudzu and other inaccessible plants can easily be reached with a projectile containing a herbicide via this foliar applied method. Irrespective of their mechanism of action to eliminate the plant, pest or insect, the present invention provides a vehicle with which to attack and eliminate unwanted elements in agriculture.

Therefore, the principal object of the present invention in an alternative embodiment is to provide a capsule that is beneficial to agriculture, horticulturists, farmers and the like in that it is a delivery system that eases the burden of issues that are common and detrimental in that field. These issues may include but are not limited to drought, insects, nutrient depleted soils, killing of weeds, adjustment to soil pH levels, and/or delivery of seeds that require a strict environment to grow.

Less than Lethal

Yet another alternative embodiment is the encapsulation of materials that can be used as alternatives to lethal projectiles. Often it is necessary for police, military and other law enforcement agencies to control riots via projectiles that incapacitate as opposed to live ammunition. This may also be desirable for home defense use, as some people are not comfortable with live ammunition. Military uses include providing identification to locations that are targets, areas to stay clear of, or even track enemy vehicles discretely. Various materials could be encapsulated using the present invention, including, but not limited to, staining and non-staining dyes, eye and respiratory irritants such as pepper powder, UV reactive inks, chemi-luminescent materials to mark targets, infrared emitting dyes and powders to track and trace, magnetic dust, scent based components for K-9 tracking, etc.

### Pharmaceutical

Still another embodiment of the present invention is to provide an encapsulation method for the delivery of drug and nutritional materials to those in need. It is possible with the present invention to encapsulate oral dosages in an outer shell that is amenable to the digestive system. The intent is to provide an alternative encapsulation system that optimizes efficacy and optimizes the therapeutic effect. One object of the present invention is to provide a method to encapsulate water. This would then provide an aqueous based excipient for oral drug delivery systems. Because the body absorbs water readily, the oral capsule would provide a more accurate dosage, and therein less side effects of medication.

### Multi-Shell Materials

Another alternative embodiment is the extrusion of different shell materials in order to provide a desired effect. The use of additive layers provides an opportunity to use more than one extrusion nozzle to dispense a first outer shell material and a second outer shell material. These may be disposed in any arrangement depending upon the desired effect. In the instance that an inner shell wall portion is hydrophobic, and an outer is hydrophilic, the requisite shell materials may be extruded and placed in the desired successive layers.

### Various Shapes

The process of additive layers also permits the outer shape of the capsule to vary. Thus, the present invention is capable of providing capsules that are oblong, oval, cubed, cylindrical, pyramidal, conical, etc. In order to achieve this, the program controlling the extrusion gantry need only to be modified to the desired shape, size, dimension, etc.

### Activator

Referring to FIGS. 6A-C, another embodiment of the present invention provides for the encapsulation of a first liquid 50, which is intended to be kept separate from a second liquid 52. Both liquids 50 and 52 are disposed within respective first and second chambers 54 and 56, and encapsulated in respective first and second shells 58 and 60. Referring to FIGS. 6A and B, the outer or first shell 58 forms a first chamber 54 having a predetermined geometry configured by the inner wall 62 of the outer shell 58. This geometry may be shaped such that they are conical, with the narrow end pointing inward 64, however any shape that is capable of piercing the inner shell 60 via pointed protrusions or conical spikes 64, to promote the mixing of the first and second liquids 50 and 52 will suffice. In this instance, a first shell 58 having an outer diameter of 1″ with a first liquid 50, may encapsulate an inner second shell 60 having an outer diameter of 0.5″ containing a second liquid 52. The conical spikes 64 formed on the inner wall 62 of the first shell 58 may be sufficient to hold in place the second shell 60, while not piercing the second shell 60 until an impact occurs subsequent to projection. Thereafter, the rupture of the second shell 60 permits the first and second liquids 50 and 52 to mix to obtain a reaction. This reaction may include, but is not limited to any plural component system such that a first, second, or even multiple materials are required to interact. Examples are chemi-luminescent reactions, polyurethanes, foams, reactive inks, etc.

In this embodiment, the construction of an interior feature that promotes fracture at point of impact is unique from the prior art and can be used to obtain a myriad of reactions.

### Through Holes

In instances where it is desirable, the present invention also permits the encapsulation of materials while providing unique geometries such as inner tubes, capsules that have through holes, or channels that pass through the capsule, while not exposing the inner encapsulated substances.

### Moving Parts

The present invention also contemplates employing the full use of successive layering by building components within components that may move and interact with each other. Small gears, plungers, channels for moving parts, etc are all possible for incorporation with the encapsulation of materials requisite for the given application.

### Tranquilizer

Since the present invention employs the use of additive layers as a method to encapsulate, it thus is also capable of building independent geometries within multiple encapsulations. In effect, moving parts can be also be incorporated into the design of capsules of the present invention. These moving parts may work together to create complex delivery systems for encapsulated liquids or solids. Thus, the fabrication of needle shaped plungers that have a predetermined volume of encapsulated materials for the delivery of sedatives, tranquilizers and other components that would be convenient to deliver without concern for their fabrication method and integrity is also contemplated by the present invention.

1. A seamless capsule for delivering a material inside said capsule to a destination requiring the encapsulated material comprising:
a shell having a uni-body construction with a fill aperture in a top portion to receive a predetermined material in a cavity defined by an inner wall of said shell, said shell having an outer wall with a predetermined configuration corresponding to the intended use of said seamless capsule; and
a cover integrally joined to said top portion of said shell to cover said aperture in said top portion of said shell after the material is disposed in said cavity; whereby, said outer wall of said shell maintains said predetermined configuration after said cover is integrally joined to said top portion of said shell, thereby maintaining the optimum performance of said seamless capsule until delivering the material to a predetermined destination.

2. The seamless capsule of claim 1 wherein said material in said shell is a liquid material.

3. The seamless capsule of claim 2 wherein said material in said shell is a liquid material for paintball use, whereby, upon the fracturing of said shell, said liquid material for paintball use is released from said shell to perform a predetermined function.

4. The seamless capsule of claim 1 wherein said material is a solid material.

5. The seamless capsule of claim 1 wherein said cover integrally joined to said top portion of said shell is integrally joined without using any adhesives.

6. The seamless capsule of claim 1 wherein said outer wall of said shell includes a spherical configuration.

7. The seamless capsule of claim 1 wherein said outer wall of said shell includes a cylindrical configuration.

8. The seamless capsule of claim 1 wherein said outer wall of said shell includes an oval configuration.

9. The seamless capsule of claim 1 wherein said material in said shell is a liquid material for agriculture use, whereby, upon the dissolving of said shell, the liquid material for agricultural use is released from said shell to perform a fertilizing function.

10. The seamless capsule of claim 1 wherein said material in said shell is a liquid material for pharmaceutical use, whereby, upon the dissolving of said shell, the liquid material for pharmaceutical use is released from said shell to perform a predetermined function.

11. A method for encapsulating a material for delivery to a predetermined destination requiring the encapsulated material, said method comprising the steps of:
fabricating a seamless shell with a fill aperture in a top portion to receive a predetermined material in a cavity defined by an inner wall of said shell, said shell having an outer wall with a predetermined configuration corresponding to the intended use of said seamless shell; and
fabricating a seamless cover upon said top portion of said seamless shell to cover said aperture in said top portion of said shell after the material is disposed in said cavity, resulting in a seamless encapsulation of the material; whereby, said seamless encapsulation provides a seamless shell with a seamless outer wall that maintains said predetermined configuration after said cover is fabricated upon said top portion of said shell, thereby maintaining the optimum performance of said seamless shell until delivering the material inside said seamless shell to a predetermined destination.

12. The method of claim 11 wherein said step of fabricating a seamless shell includes the step of providing a 3 D Printer programmed to construct a seamless shell with a relatively small aperture in a top portion of said seamless shell, said relatively small aperture removably receiving a cooperating fill nozzle for dispensing a predetermined liquid material inside said cavity until substantially filling said cavity with the liquid material.

13. The method of claim 12 wherein said step of fabricating a seamless shell includes the step of providing a 3 D Printer programmed to construct a seamless cover over said relatively small aperture such that said seamless cover is integrally joined to said top portion of said shell, whereby, said predetermined shell configuration is maintained, thereby maintaining the optimum performance of said shell with the predetermined material substantially filling cavity within said seamless shells.

14. A method for manufacturing multiple capsules for encapsulating a material for delivery to a predetermined destination requiring the encapsulated material, said method comprising the steps of:
fabricating multiple seamless shells with each having a fill aperture in a top portion to receive a predetermined material in a cavity defined by an inner wall of said shell, each seamless shell having an outer wall with a predetermined configuration corresponding to the intended use of said seamless shell; and
fabricating multiple seamless covers upon each of said top portions of said multiple seamless shells to cover each of said apertures in each of said top portions of said multiple shells after the material is disposed in each of said cavities, resulting in multiple seamless encapsulations of the material; whereby, said seamless encapsulations provide multiple seamless shells each with a seamless outer wall that maintains said predetermined configuration after said covers are fabricated upon said top portions of said shells, thereby maintaining the optimum performance of said multiple seamless shells until delivering the material inside each of said seamless shells to predetermined destinations.

15. The method of claim 14 wherein said step of fabricating multiple seamless shells includes the step of providing a 3 D Printer programmed to construct multiple seamless shells each with a relatively small aperture in a top portion of said seamless shells, said relatively small apertures removably receiving a cooperating fill nozzle for dispensing a predetermined liquid material inside each cavity of said multiple seamless shells until substantially filling each cavity with the liquid material.

16. The method of claim 15 wherein said step of fabricating multiple seamless shells includes the step of providing a 3 D Printer programmed to construct multiple seamless covers over said relatively small apertures such that each of said seamless covers is integrally joined to a top portion of each of said multiple shells, whereby, each predetermined shell configuration is maintained, thereby maintaining the optimum performance of said shells with the predetermined material substantially filling each cavity within said seamless shells.

17. The method of claim 15 wherein said step of providing a 3 D Printer programmed to construct multiple seamless shells includes the step of fabricating multiple seamless shells upon one build platform, said 3 D Printer including a first gantry for supporting multiple seamless shell forming ejectors with bottom nozzles, said ejectors fabricating and equally separating shells upon said build platform under said ejectors.

18. The method of claim 17 wherein said step of fabricating multiple seamless shells upon one build platform includes the step of filling said multiple seamless shells with the predetermined material via a second gantry supporting a corresponding predetermined material fill ejector with bottom nozzles for each seamless shell forming ejector for ejecting the predetermined material into each seamless shell via said fill aperture.

19. The method of claim 18 wherein said step of fabricating multiple seamless shells upon one build platform includes the step of programming said 3 D Printer to control horizontal movement of said first and second gantries upon a lower platform, and controlling horizontal and vertical movement of said seamless shell forming ejectors secured to said first gantry, and controlling horizontal and vertical movement of the predetermined material ejectors secured to said second gantry.

20. The method of claim 17 wherein said step of fabricating multiple seamless shells upon one build platform includes the step of programming said 3 D Printer to control horizontal movement of said first gantry that supports both shell forming ejectors and predetermined material fill ejectors such that both shell forming and fill ejectors may be horizontally and vertically positioned upon said first gantry to facilitate multiple seamless shell forming and seamless shell filling steps for manufacturing multiple capsules for encapsulating a material for delivery to a predetermined destination requiring the encapsulated material.
